(19) United States
(12) Patent Application Publication
(10) Pub. No.: US 2012/0152120 A1
(43) Pub. Date: Jun. 21, 2012

(54) PRODUCTION OF CARBON DIOXIDE FROM SYNTHESIS GAS

(75) Inventors: Lamar A Davis, West Dundee, IL (US); Nagaraju Palla, Woodridge, IL (US); Ernest J. Boehm, JR., Hanover Park, IL (US)

(73) Assignee: UOP LLC, Des Plaines, IL (US)

(21) Appl. No.: 13/306,223

(22) Filed: Nov. 29, 2011

Related U.S. Application Data
(60) Provisional application No. 61/423,328, filed on Dec. 15, 2010.

(51) Int. Cl. B01D 53/14

(52) U.S. Cl. 95/229

(57) ABSTRACT

The present invention provides a series of processing steps to remove carbon dioxide from synthesis gas. The syngas exiting a hydrogen sulfide absorber is first compressed, subjected to a dehydration step and a low temperature liquefaction and separation to remove carbon dioxide. The high pressure syngas then continues on to a carbon dioxide absorber for carbon dioxide removal. The system can operate with lower solvent rates and equipment sizes compared to prior art systems.

### CROSS-REFERENCE TO RELATED APPLICATION

This application claims priority from Provisional Application No. 61/423,328 filed Dec. 15, 2010, the contents of which are hereby incorporated by reference.

### BACKGROUND OF THE INVENTION

This invention relates to separation of gases. More particularly, it relates to purification of a hydrogen-rich stream, such as a synthesis gas (syngas) stream, by removal of acid gases, carbon dioxide, hydrogen sulfide and carbon monoxide. The invention further relates to a method for removal of carbon dioxide that requires significantly less energy than prior art processes.

There is increasing concern about combustion of fossil fuels worldwide because of the emission of carbon dioxide. Atmospheric CO₂ is believed capable of producing a “greenhouse effect” by trapping radiated heat from the earth's surface, thereby contributing to global warming. Although emission of CO₂ to the atmosphere is not yet regulated, the issue is one of such rising political concern that future regulation is a strong possibility and worthy of new technology and invention to address the problem. It has been proposed in many technological forums that a way to limit the emission of CO₂ from fossil fuels is to utilize the energy in the fossil fuel to make hydrogen, which emits only water vapor when combusted. During hydrogen production, the carbon in the fossil fuel is converted to CO₂. Under current proposals, the CO₂ is then separated from the hydrogen and compressed to a high pressure for disposal. The high pressure is necessary for carrying out the most commonly proposed method of disposal: sequestration by deep underground or deep ocean containment. Although many commercial processes are available to produce purified hydrogen and CO₂, the energy consumed by undertaking both the separation process and the CO₂compression process is quite high, making current processes economically unattractive. Our invention proposes a process to greatly decrease this energy consumption.

The processes for making hydrogen from fossil fuels are well-known. One broad class of these processes is gasification, in which a carbonaceous fuel (e.g., coal) is partially oxidized at high temperature and elevated pressure in the presence of water vapor to form mainly carbon monoxide (CO) and hydrogen (H₂S). Then by the well known water-gas shift conversion reaction, the carbon monoxide is reacted with water vapor over a catalyst to form additional hydrogen and carbon dioxide. Sulfur in the fossil fuel is converted mainly to hydrogen sulfide during gasification. The hydrogen is then purified to remove CO₂and H₂S by a well known process method commonly called acid gas removal (so named because the compounds CO₂ and H₂S will ionize in water to form mildly acidic solutions).

There are numerous methods for acid gas removal. Most commercially-applied processes use some form of solvent that has an affinity for acid gases. The solvents vary broadly and include chemical substances such as monoethanolamine in water, chilled methanol, or hot potassium carbonate ionized in water. The reference book Gas Purification, fifth edition, lists more than a dozen solvent-based processes for acid gas removal. Typically, the acid gases are absorbed into the solvent in an absorption tower to form a solvent stream rich in acid gases. Acid gases are then removed from the rich solvent by some combination of flashing at reduced pressure, stripping with a medium of nitrogen or steam, and/or distillation of the solvent. The solvent, now lean with respect to acid gases, is then returned to the absorption tower.

A chief drawback to these solvent-based acid gas removal processes is that a significant quantity of energy, either in the form of steam or electricity, is required to regenerate the solvent. The very act of diluting the acid gases within a solvent means that significant energy is required to reconstitute the acid gases as a pure stream. This energy penalty is made worse if the acid gases must be pressurized for sequestration. The pressure lost during flashing of the solvent at a reduced pressure must then be restored by compression of the acid gases. Even further energy must be expended if the H₂S must be separated from the CO₂ prior to sequestering the CO₂ (an issue which has yet to be settled by environmental regulation).

In a typical gasification design that uses absorption technology for segregation of H₂S and CO₂ removal into their respective purified streams, the CO₂ produced is at a pressure such that a large amount of compression is required to get the CO₂ to a pressure that is sufficient for geologic sequestration or enhanced oil recovery (EOR) applications. This requirement for CO₂ compression has been found to be equivalent to three to four times the energy requirement for the absorption unit itself. This cost, both in capital and operating expenses, is prohibitive.

Another problem with the prior art design is that the industry is starting to require more stringent specifications on the CO₂ impurities. In addition, recently the industry put forth a very tight specification on the CO content of the purified CO₂ stream due to environmental emissions in the event that the CO₂ cannot be sequestered.

A prior art design attempted to solve this problem by using a recycle flash drum to flash off the CO (along with H₂, CH₄, etc) at a reduced pressure and compress it back into the CO₂ absorber column. This is done prior to the bulk of the CO2 being flashed off in the remaining medium pressure and low pressure CO₂ flash drums. The problem with the prior art design is that the CO₂ recycle system has very operating and capital expenses, and for very low CO specifications in the CO₂, this expense becomes prohibitive. Clearly, a less costly means of delivering purified CO₂ at high pressure would be highly valued.

The present invention uses some elements of the prior art without modification. The present invention involves, but does not explicitly include, the use of a series of processing steps to remove CO₂ from the syngas exiting the top of the H₂S Absorber. These include, but are not limited to, a compression step to boost pressure to approximately 7584 kPa (1100 psig), a dehydration step to remove water, and a low temperature liquefaction and separation to remove CO₂ from the syngas stream. This series of steps removes approximately 80% of the CO₂ from the syngas stream and delivers it to battery limits as a high pressure, high purity dense phase stream. The now high pressure syngas continues on to the CO₂ absorber for CO₂ removal, which benefits greatly from the increase pressure by allowing lower solvent rates and equipment sizes. The CO₂ that remains in the syngas entering the CO₂ absorber is removed as before in a series of flash drums. The present invention explicitly includes the integration of recycling the CO2 from all of the flash drums back into the series of processing steps instead of separately disposing of the carbon dioxide from the flash drums.

The benefits of this invention are significantly lowered capital expenditures and significantly lowered operating expenditures. In one analysis, the operating savings, can approach 40 megawatts of electricity alone. This invention has particular application in situations where it is desired to have a low carbon monoxide level in the carbon dioxide product stream.

1. A process for treating a synthesis gas comprising:
a) removing hydrogen sulfide from said synthesis gas;
b) compressing said synthesis gas to produce a compressed stream of synthesis gas;
c) dehydrating said compressed stream of synthesis gas to produce a dry compressed stream of synthesis gas;
d) cooling said dry compressed stream of synthesis gas to remove a majority of carbon dioxide from said dry compressed stream of synthesis gas to produce a partially purified stream of synthesis gas and a product stream of carbon dioxide;
e) sending said partially purified stream of synthesis gas first to a carbon dioxide absorber to produce a stream of purified synthesis gas and a stream comprising carbon dioxide; and
f) returning said stream comprising carbon dioxide to steps (b), (c) and (d) to add additional carbon dioxide to said product stream of carbon dioxide.

2. The process of claim 1 wherein said stream comprising carbon dioxide is first compressed before being returned to said steps (b), (c) and (d).

3. The process of claim 1 wherein said synthesis gas is compressed to about 7584 kPa (1100 psig).

4. The process of claim 1 wherein said stream comprising carbon dioxide is sent from said carbon dioxide absorber to at least one flash drum before being sent to said steps (b), (c) and (d)

5. The process of claim 4 wherein said at least one flash drum comprise at least one recycle flash drum, at least one medium pressure flash drum and at least one low pressure flash drum.

6. The process of claim 4 wherein after passing through said at least one flash drum, said carbon dioxide is compressed to form a compressed stream of carbon dioxide.
